(19) United States
(12) Patent Application Publication
(10) Pub. No.: US 2005/0171918 A1
(43) Pub. Date: Aug. 4, 2005

(54) Method and system of cost variance analysis

(76) Inventors: Ronald Eden, Ottawa (CA); Colin M. Lay, Nepean (CA)

Correspondence Address: Sommer Barnard Attorneys, One Indiana Square, Suite 3500, Indianapolis, IN, 46204, US

(21) Appl. No.: 10/507,409

(22) PCT Filed: Mar. 13, 2003
(86) PCT No.: PCT/CA03/00352

Related U.S. Application Data
(60) Provisional application No. 60/363,964, filed on Mar. 14, 2002.

(51) Int. Cl. G06F 17/00

(52) U.S. Cl. 705/400

(57) ABSTRACT

A method for cost variance analysis for assessment of the effects of products/product groups, activities/activity-producing-departments, and resource acquisition, within an organization. The method utilizes the Broyles and Lay p′RUm cost variance model. By converting one or more variables of the Broyles and Lay model into a diagonal or grouped matrix, effects within departments can be apportioned, to identify problematic factors, as well as areas of opportunity. A related method of revenue and profit variance analysis. Revenues are calculated as (Selling Prices)×(Volume and mix of products). Revenue variances are the difference between actual and budgeted revenues, and can be attributed to the changes in selling prices and volume and mix of products. Profit is defined as revenue less cost Profit variances depend on both revenue and cost variances.

This application claims priority from U.S. provisional patent application Ser. No. 60/363,964 filed Mar. 14, 2002.

### FIELD OF THE INVENTION

The present invention relates to accounting methods. In particular, the present invention relates to a method of revenue, profit and cost variance analysis.

### BACKGROUND OF THE INVENTION

Accounting reports provided to department/budget managers often present 3 columns showing budget numbers, actual spending numbers, and the differences, or “variances”. In this traditional variance analysis the manager is expected to explain why the variances occurred, but has little evidence to support any explanation. This traditional variance analysis is devoid of any theoretical basis. A new cost variance model, termed “p′RUm”, published in 1982 by Broyles and Lay, (Broyles, Robert W. and Colin M. Lay, “Budgeting and Controllable Cost Variances—The Case of Multiple Diagnoses, Multiple Services, and Multiple Resources,” Journal of Medical Systems, Vol. 6, No. 6, 1982) which is incorporated herein by reference, was proposed for specific application to variance analysis in hospitals to provide evidence about reasons for changes, but was applicable only at the summary level for the whole hospital. The Broyles and Lay model was based on cost accounting and standard costing concepts.

Activity-based costing (ABC) has dominated discussion of new techniques in accounting since proposed in 1988 by Cooper and Kaplan, (Cooper, Robin and Robert S. Kaplan (1988), “How Cost Accounting Systematically Distorts Product Costs,” Management Accounting, April 1988, pp. 20-27). In the early 1990s a colleague commented to Prof. Lay that the Broyles and Lay p′RUm model was an ABC model. ABC assumes that resources are consumed in carrying out activities, and that the activities are used to create the products or cost objects.

The primary dominant theme in the accounting literature discussion of ABC focuses on how to create more efficient sets of activities, by re-engineering, combining or eliminating them, so that the cost objects will have the most appropriate content and cost. Attention is paid to the detailed structure of each activity, and to the “cost drivers” that lead to higher or lower volume and cost for the activity. The cost drivers may be directly related to the volume of output of the final products of the organization, or to product or organizational development cost objects. The secondary theme in academic discussions of ABC since 1988 has been the statistical estimation of the effects of possible cost drivers, to determine their relative importance.

The Broyles and Lay p′RUm model complements the discussion and practice of ordinary cost accounting and standard costing and ABC. It assumes that production activities are already being carried out, and that there are defined sets of activities whose costs have been determined through some costing process. Most organizations have many cost centers (often hundreds, even thousands) where the activities are carried out Many activities are performed only in a single cost center, but others may be carried out in several different cost centers. These activities are used to produce the cost objects that constitute the final products of the organization. In some manufacturing organizations there is little variability in the activities used to produce the products, but in other types of organizations, most notably service producing ones, the activity content of each product may be extremely variable, as is the case specifically in health care organizations. A manufacturing organization's “bill of materials” is replaced by a hospital's “care map,” or “treatment protocol,” potentially one for each of several hundred different types of patients. Other service organizations would have analogous “service maps.”

The Broyles and Lay p′RUm cost variance model assumes that the budgeted expense of an organization can be generated as the matrix product shown in Equation 1, wherein the values in these vectors and matrices have been determined by some budgeting or planning process.
Budgeted expense=[(resource prices)×(Resources used in activities)×(activities Utilized per unit product)×(volume & mix of products)] Equation 1

By measuring the actual values of each of these factors, and performing the same multiplication, one arrives at the actual expenses. Subtracting actual less budget, gives the variance. Since there are multiple types of resources, activities and products, the data must be (explicitly or implicitly) represented as vectors and matrices, and the multiplications are done using matrix algebra (which may be represented explicitly in some computer languages, or implicitly in others). The Broyles and Lay p′RUm model developed the basic ideas of a new type of variance analysis which distinguishes the effects of the 4 main factors and their interactions. However, the model only developed the ideas for a single level: the overall organization. After its 1982 publication, the Broyles and Lay p′RUm model remained ignored and unused in general practice because of a lack of sufficient computing power, and lack of motivation arising from not-yet-felt pressures for productivity and cost reduction. Although others have proposed some aspects of data collection and presentation that are relevant for the Broyles and Lay p′RUm model, none have suggested a comprehensive model.

In recent years there has been increasing interest in the software industry to have large databases (called data warehouses, data marts, data cubes, Online Analytical Processing, business intelligence, and other names) to record activities, outputs and costs, and to provide software to enable users to “drill down” to analyze problems in their organizations. However, many such products fall into a category of empirically based costing “special study” approaches, and would be complemented by a comprehensive model of cost variance analysis.

In the accounting and management literatures, there has been much discussion both of activity-based costing (ABC) and activity-based cost management (ABCM) as proposed replacements for standard costing and management using standard costing. The simplest expression of ABC is that resources flow into activities for which costs can be determined. Activities are consumed by the cost objects (products) at different rates, and the processes that determine those rates are called cost drivers. The proponents of ABC believe that these flows can be measured more or less accurately. Challenges in ABC include optimization of the activity costs and cost object use of activities, as well as determining the nature of, and how to measure the impact of, the cost drivers.

The Broyles and Lay p′RUm model was oriented to a hospital context. It showed how to separate the components of the cost variance caused by changes in the four major determinants of cost for a production process:
(a) the prices paid for input resources;
(b) the Resources consumed in carrying out activities;
(c) the Utilization of activities (services) in the production of the outputs, and;
(d) the mix and volume of outputs (patients treated).
   Further, all levels of interaction among these four major determinants can be assessed.

In cost variance reporting, as traditionally practiced, managers are asked to explain variances that arise from a mixture of influences, only some of which are within their realm of responsibility. They have no tools to disentangle those influences, but are asked to do so anyway. The result is that often the explanation becomes one of “finger pointing” at other people as the culprits. No one in the organization can easily say what the size of the effects from each of the causes might be. “Special studies” are often carried out to determine the cause of a specific problem, but these special studies are often flawed because they unwittingly leave out important factors.

Traditional accounting variance figures are not able to distinguish important causes of differences between actual and budgeted costs, and special studies are not comprehensive in their scope and may omit important factors. There is a need for a comprehensive method of cost variance analysis that can determine the influence of all variables simultaneously on the analysis. Furthermore, the presentation must allow individual managers to determine which factors they control, and which factors are controlled by all other managers.

### SUMMARY OF THE INVENTION

It is therefore desirable to provide a method of variance analysis that obviates or mitigates one or more of the deficiencies of the prior art. It is further desirable to provide a method of cost variance analysis which allows apportioning of the influences of multiple variables on the total analysis. It is also desirable to provide a method of variance analysis for revenues and profit.

The present invention provides a method of cost variance analysis comprising the steps of: a) assessing variables p (price), R (efficiency), U (utilization) and m (product mix), at least one of the variables being a variable of interest comprising a plurality of influencing factors; b) expressing the variable of interest as a diagonal matrix, or a grouped matrix, having a plurality of columns, each column representing an influencing factor; c) conducting p′RUm analysis according to Broyles and Lay, substituting the diagonal matrix, or the grouped matrix, for the variable of interest; and d) assessing the impact of an influencing factor on cost variance attributable to said variable of interest.

Further, the invention provides a method of cost variance analysis using p′RUm analysis according to Broyles and Lay, having variables p (price), R (efficiency), U (utilization) and m (product mix), at least one of the variables being a variable of interest comprising a plurality of influencing factors, having an improvement comprising the steps of: a) expressing the variable of interest as a diagonal matrix, or a grouped matrix, having a plurality of columns, each column representing an influencing factor; and b) assessing the impact of an influencing factor on cost variance attributable to said variable of interest.

The invention allows for one or more of the following advantages:
1. the adaptation of the p′RUm cost variance analysis at the program and department and resource acquisition levels can be assessed;
2. the derivation of revenue and profit variances and their relationship to cost variances can be determined;
3. the formatting and presentation of the variance analysis results both in tabular and graphical form; and
4. the use of sparse matrix techniques, permits large empty blocks in the data, to avoid unnecessary storage of, or calculation with, zeros.

According to the invention, the method for cost variance analysis modifies the original p′RUm model and advantageously imparts utility to the model by providing cost variance information to groups of managers who have responsibility for one or more dimensions of cost, by converting variables within the equation into a diagonal matrix as follows:
(a) products/product-groups, when the variable of product mix (m) is converted to a diagonal matrix, or a grouped matrix;
(b) activities/activity-producing-departments, when the combined variables of Utilization of activities and mix and volume of outputs (Um) are converted to a diagonal matrix, or a grouped matrix, in a manner analogous to a (above); and
(c) resource acquisition, when the combined variables of Resources consumed, Utilization of activities, and mix and volume of outputs (RUm) are converted to a diagonal matrix, or to a grouped matrix, in a manner analogous to a (above).

This invention solves the problem of the prior art methods of cost variance reporting by separating the causes of variance, and including all influences and their interactions, for each unit within an organization. This will advantageously assist managers of units to determine the effects of variables of interest within their own spans of control, and to determine the effects of variables of interest under the control of other managers. This is a comprehensive analysis because each manager sees the totality of all influencing variables of interest, both those under their own control, and those controlled by other managers, and those which are not controllable inside the organization. Each manager sees the influences in the perspective of his/her/their own sphere of activities. These spheres comprise products and product-groups, activities and activity-producing-departments, and resource acquisition.

In addition, the present invention provides a method of revenue and profit variance analysis using an extension of p′RUm analysis, having variables sp (selling price) and m (product mix), at least one of the variables being a variable of interest, comprising:
(a) determining profit and revenue variances between actual and budgeted revenues; and
(b) assessing impact of an influencing factor on profit and revenue variance attributable to said variable of interest.

### BRIEF DESCRIPTION OF THE DRAWINGS

Preferred embodiments of the present invention will now be described, by way of example only, with reference to the attached Figures, wherein:

FIGS. 1A and 1B illustrate output generated using the p′RUm method of cost variance analysis according to Broyles and Lay, in a hospital context where products and product groups refer to patient-types and groups of patient types;

FIGS. 2A-2E illustrate tabular and graphical presentations demonstrating the attribution of cost variance to a patient type or product-group within a product mix as described in Example 1;

FIGS. 3A-3D illustrate tabular and graphical presentations demonstrating the cost variance analysis at the activity and activity-producing department dimension as described in Example 2;

FIGS. 4A-4D illustrate tabular and graphical presentations demonstrating the cost variance analysis at the resource acquisition dimension as described in Example 3;

FIG. 5A illustrates the addition of revenue and profit variances to Broyles and Lay as described in Example 4;

FIGS. 5B and 5C illustrate tabular presentations demonstrating the variance analysis at the revenue and profit dimensions as described in Example 4, FIGS. 5A and 5C contribute to the graphical presentation of Revenue, Profit and Cost Variances in FIG. 2C;

FIG. 5D repeats the graphical presentation of FIG. 2C demonstrating the attribution of cost variances to patient types within a product mix as described in Example 1, except that the range of values on the y axes has been fixed instead of being allowed to vary, in order to better portray the relative importance of the variances of the different patient types;

FIG. 6 illustrates the method of developing the detailed analysis of activity managers' efficiency impact on resources and products;

FIG. 7 illustrates detailed information generated using the invention, presented to activity managers to show the overall impact of their efficiency changes on resources and products;

FIG. 8 illustrates detailed information generated using the invention, presented to product managers to show the overall impact of their utilization changes (treatment protocols, care maps, bills of materials, etc) on resources and activities;

FIG. 9 is a graphical presentation of the sources of data for the p′RUm method of cost variance according to Broyles and Lay applied to a typical hospital; and

FIG. 10 is a graphical presentation of elements of the p′RUm method according to Broyles and Lay and the improvement according to the present invention.

### DETAILED DESCRIPTION OF THE PREFERRED EMBODIMENTS

In one embodiment, the method may be used for cost variance analysis within a service providing organization or institution, such as a hospital.

A feature of this method is that the sum of the variances caused by changes in the four major determinants of cost, and their interactions, gives the total accounting variance for the organization. This is true, individually and collectively, for each of the above-noted dimensions.

The invention is useful for organizations already using standard costing, activity-based costing or empirical (ad hoc) cost accounting. The inventive method departs from the Broyles and Lay p′RUm model to examine revenue and profit variances, and to analyze them in relationship to the cost variances, for managers in either the total organization dimension, and/or within one or more of the product/product-group dimension; the activity and activity-producing department dimension, and the resource acquisition dimension.

Thus, a manager will be able to determine how revenue and profit variances are affected by their unit of responsibility.

Cost variance analysis can be assessed by evaluating the variables of p (price), R (efficiency), U (utilization) and m (product mix), at least one of which is a variable of interest having more than one influencing factor. The variable of interest is then expressed as a diagonal matrix having separate column representing each influencing factor. The conventional p′RUm analysis is then conducted, substituting the diagonal matrix for the variable of interest; and the impact of an influencing factor on cost variance can then be attributed within a variable of interest. Tabular and graphical formats can be used to present the analyses dearly, in a way which differs from the traditional presentation of variance numbers in accounting reports.

Sparse matrix techniques can be applied to the cost variance analysis method, to reduce the burden of computation in the model by avoiding unnecessary multiplication by zeros in portions of the model where the data are blank. Multiplying by zero is a waste of computational time, since the result is zero. Most departments are responsible for a small subset of the total set of activities performed by the organization in creating the products of the organization. These departments also use a small subset of the resources acquired by the organization (such as different types of labor).

The method allows each product manager, activity department manager, and resource acquisition manager to distinguish the impact of a change in any of the four major determinants of cost on their own area of responsibility. Further, such managers can then determine which parts of their cost variances are under their own control, which parts are the responsibility of others in the organization, and which parts have shared responsibility. This new approach overcomes a major, unrecognized deficiency of traditional methods of presenting accounting variance information, in which cost variances from different sources can partially offset each other (some positive and some negative) thus obscuring real problems, or opportunities, for the organization.

The method allows apportioning of the total variance of the organization to a particular unit of responsibility. Problematic areas can then be identified, as well as beneficial areas or future opportunities within an organization.

The process can be programmed into, or added as a new module to, the accounting systems of any organizations seriously using ad hoc cost accounting, standard costing, or activity-based costing accounting systems. Its application will enable these organizations to diagnose much more explicitly the causes of costs being over or under budget, and will relate them as well, to the revenues being received from the sale of the goods or services.

The “end users” would be hospitals and other health services organizations, educational institutions, other service organizations, and manufacturing organizations which are using or implementing standard costing or activity-based costing.

The p′RUm Model for Activity Based Management

The basis of the p′RUm model is an expansion of the familiar equation, cost=price×volume. Prices of input factors (resources) are labeled “p.” The “volume” can be calculated using three variables:

resources used to produce activities (R),

utilization of activities to create products (U),

and the mix and volume of products (m).

Then total cost=p×R×U×m, or cost=pRUm.

Price is expressed in a row vector, p′, which is measured in dollars per unit of input resource, such as the various types of labor, or the various types of supplies. (In countries where the currency unit is not a “dollar” the local currency unit can be used in place of “dollar”.) Most activities will require several different input resources (different types of labor and supplies). This is expressed with resources as rows and activities as columns in a matrix, R, measured in units of input resources per unit of activity. Different kinds of products require different sets of activities for their production, and the various production protocols are expressed with activities as rows and product protocols as columns in the matrix U, measured in units of activities per product. Finally the mix and volume of products is expressed in a column vector, m, measured in numbers of products produced/sold.

Total cost should be dollars, and using dimensional analysis, we can see easily that multiplying p×R×U×m gives dollars. That is:

$$\frac{[ \$ ]}{[ unit of input resource ]} \times \frac{[ units of input resources ]}{[ unit of activity ]} \times \frac{[ units of activity ]}{[ unit of product ]} \times [ units of products ] = \$$$

The products of various components can be assessed to see what meaning they give:
p×R=[$/unit activity]
   (eg. $/welding operation; or $/lab test; or $/nursing day in ICU).
p×R×U=[$/product]
   (eg. $/car; or $/software package; or $/student; or $/patient treated).
R×U=[units of input resources/product]
   (eg. welding time/car produced; sales representative time per software package)
U×m=[total units of activity]
   (eg. welding operations, sales calls, lab tests)
R×U×m=[total units of input resources]
   (eg welding time, sales time, professor time, nurse time)
      Original Method of Cost Variance Analysis Using the p′RUm Model

According to the original pRUm model, if we use the subscript a to represent actual and b to represent budget values, then the actual total cost can be represented by p′RUmₐ and the budgeted total cost by p′RUm_{b}. Accounting cost variances are defined as actual cost minus budgeted cost, and positive cost variances are unfavorable. In the model, then:
the total cost variance=p′RUmₐ−p′RUm_{b}

Rather than use the subscripts on each vector or matrix in the terms of an expression, the subscripts are used to apply to every preceding component of the term in the expression, unless they are specifically needed to differentiate. Thus in the first term of the total cost variance expression, p′RUmₐ, the subscript a refers to all four of the components. They are all actual values. In the second term, p′RUm_{b}, they are all budgeted values. This practice avoids creating an unnecessary clutter of subscripts. Herein, the subscripts are used where necessary for clarity of meaning or intention.

The potential utility of the p′RUm model comes from the fact that the total cost variance can be separated into a series of components which allow closer inspection of the causes of the variance, and identification of individuals responsible for controlling the variance.

There is a component for each of the four main effects, p, R, U and m, and then a series of 2-way and then 3 way interactions, and finally the interaction of all four main effects.

Matrix algebra allows very simple expression of the variance components, as follows:
Price variance (p)=(p′ₐ−p′_{b})RUm_{b}
Efficiency variance (R)=p′_{b}(Rₐ−R_{b})UM_{b}
Utilization variance (U)=p′R_{b}(Uₐ−U_{b})m_{b}
Product mix variance (m)=p′RU_{b}(mₐ−m_{b})

Only the components marked with a subscript a have actual values, the others are budgeted, and marked sparingly with the subscript b.
The two-way interactions are:
   Price, Efficiency (p, R)=(p′ₐ−p′_{b})(Rₐ−R_{b})Um_{b}
   Price, Utilization (p, U)=(p′ₐ−p′_{b})R_{b}(Uₐ−U_{b})m_{b}
   Price, Product mix (p, m)=(p′ₐ−p′_{b})RU_{b}(mₐ−m_{b})
   Efficiency, Utilization (R, U)=p′_{b}(Rₐ−R_{b})(Uₐ−U_{b})m_{b}
   Efficiency, Product mix (R, m)=p′_{b}(Rₐ−R_{b})U_{b}(mₐ−m_{b})
   Utilization, Product mix (U, m)=p′R_{b}(Uₐ−U_{b})(mₐ−m_{b})
The three-way interactions are:
   Price, Efficiency, Utilization (p, R, U)=(p′ₐ−p′_{b})(Rₐ−R_{b})(Uₐ−U_{b})m_{b}
   Price, Efficiency, Product mix (p, R, m)=(p′ₐ−p′_{b})(Rₐ−R_{b})U_{b}(mₐ−m_{b})
   Price, Utilization, Product mix (p,U,m)=(p′ₐ−p′_{b})R_{b}(Uₐ−U_{b})(mₐ−m_{b})
   Efficiency, Utilization, Product mix (R, U, m)=p′_{b}(Rₐ−R_{b})(Uₐ−U_{b})(mₐ−m_{b})
The four-way interaction is:
   Price, Efficiency, Utilization, Product mix (p, R, U, m)=(p′ₐ−p′_{b})(Rₐ−R_{b})(Uₐ−U_{b})(mₐ−m_{b})

The sum of the four main components and all the interactions is the total cost variance.

In one embodiment, the present invention can be implemented on a general purpose computer including a CPU, and memory device using a programming language as described below.

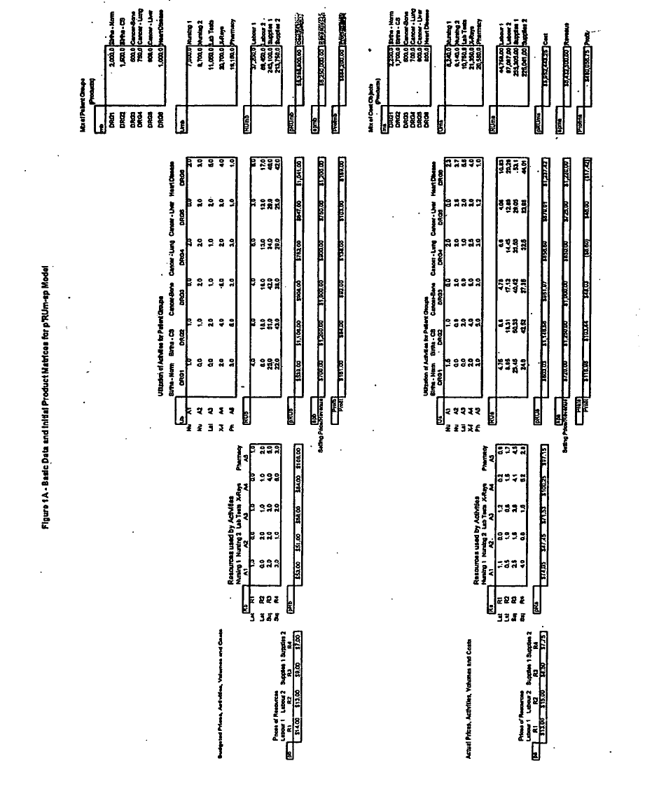

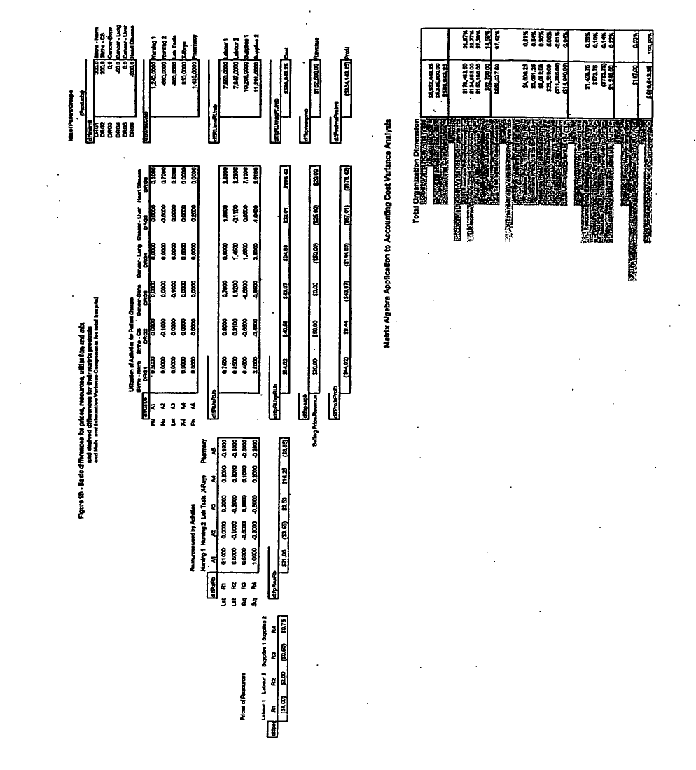

Although the equations are simple, most computer languages require complex programming to put the equations into practice. The programming language APL and its successor, J, make the programming simple. QuattroPro and Excel software can also be used. The method can be a computer program product comprising a computer program stored on a machine readable medium such as a CDROM or floppy disc. FIG. 1A indicates the sources of data for the p′RUm method for a typical hospital. The patient oriented clinical data systems (nursing, labs, etc) are highly specialized components which collectively form the electronic patient record. The indirect care departments provide services which support the activities of all of the clinical departments. The administrative accounting systems for reporting the dollars spent in each of the direct and indirect care departments are crucial for developing the cost figures for understanding the cost of providing patient care. The departmental accounting reports provide the budget, actual and variance figures whose deficiencies are the reason for the development of improved approaches proposed in this work. Cost allocation rules are important for determining how certain of the indirect care costs are apportioned to the care of particular patient groups. Cost allocation rules are an important component of patient specific costing in health care, and of Activity Based Costing in general. All of the data from the various patient care and administrative systems are processed and stored in a conventional data warehouse and in a hospital this data warehouse is highly specialized to the patient care costing requirements.

Specialized queries from the data warehouse provide the data which are the primary data for the p′RUm model. The p′ vector is the average purchase price of the resources used in the patient care processes in the time period in question. Ihe R matrix is the average amount of each type of resource used in the production of each kind of service provided to patients. The U matrix is the average number of each kind of service utilized in the treatments of individual patients from each defined group of patients. The m vector is the count of the number of patients in each identified group (ie. the mix of patients). Typical outputs generated by the original method according to Broyles and Lay are shown in FIGS. 1A and 1B.

An Example Presented as a Spreadsheet Method

FIGS. 1A and 1B show the spreadsheet method for a simple model with 4 resources (R1-R4), 5 activities (A1-A5), and 6 cost objects (DRG1-DRG6). This example is set in a hospital. The resources represent 2 types of labour and 2 types of supplies. The activities are taken to be 2 levels of nursing care, laboratory tests, diagnostic imaging tests (x-rays), and pharmaceutical prescriptions. The cost objects are six Diagnosis Related Groups (DRGs) representing types of patients being treated, which we will assume are 2 types of deliveries (births), 3 types of cancers, and heart disease. Both budgeted and actual values of the data are shown in FIG. 1A. The Unit Prices of Resources are given in the row vectors pb and pa. The units of Resources used by Activities are given in the matrices Rb and Ra. The units of Utilization of Activities for Patient Types are given in the matrices Ub and Ua. For each type of patient there is a column in the U matrices, and this is a representation of information about the activities specified in the treatment protocol or care map. The numbers of patients treated, the Patient Mix, are given in the column vectors mb and ma. The product of (Prices of Resources) times (Resources Used by Activities) is given by pRb and pRa, and these are the budgeted and actual unit costs of each of the activities: $/NursingDay (2 levels), $/LabTest, $/Xray, and $/prescription. The product of (Resources Used by Activities) times (Utilization of Activities for Cost Objects) is given by RUb and RUa, and these are the budgeted and actual units of resources consumed by each type of patient. The product of (Utilization of Activities for Patient Types) times (Patient Mix) is given by Umb and Uma, and these are the budgeted and actual activities used to treat the patients in the hospital. The budgeted and actual unit costs of treating each of the types of patients are given by the products pRUb and pRUa, which are the products of p,R and U. The final products pRUmb and pRUma are the total budgeted and actual costs of treating all the patients in the hospital.

The basic method has been extended by adding a vector of reimbursement prices for each kind of patient. The budgeted and actual selling price/revenue are labeled spb and spa, and when these vectors are multiplied by the Mix of Cost Objects, mb and ma, the products spmb and spma are the total budgeted and actual patient revenue. Subtracting, Revenue minus cost, gives profit, both unit profit Profb and Profa and total profit Profmb and Profma. Again these are budgeted and actual values.

FIG. 1B shows variances in two forms. The top half shows the simple differences of the cost vectors and matrices from FIG. 1A, which are defined as actual values minus budgeted values. Thus pa-pb gives diffpapb, and Ra-Rb gives diffRaRb, and so on, until diffpRUmapRUmb which is the difference between the actual and budgeted total costs of treating the patients. Note that this is $566,643.25.

The bottom half of FIG. 1B shows the Broyles and Lay p′RUm Cost Variance Analysis. The “Total Organization Dimension Cost Variance Analysis” is a summary for the total hospital. The Actual Total Cost of $5,952,443.25 is $566,643.25 higher than the budgeted figure, which is an unfavourable variance. The four Main Cost Variance Components account for just over 97% of the total variance. (This total may vary remarkably in different situations.)

Main Cost Variance Components

| | | |
|---|---|---|
| Resource Price Variance (p) = | $179,462.50 | 31.67% |
| Resource Conversion Efficiency Variance(R) = | $134,695.00 | 23.77% |
| Activity Utilization Variance(U) = | $155,180.00 | 27.39% |
| Product (Cost Object) Mix Variance (m) = | $82,700.00 | 14.59% |
| Total of Main Components | $552,037.50 | 97.42% |

The component caused by changes in prices is the largest, but the other three are also sizable. In this case, all four components are positive, with actual costs being higher than budgeted. They are unfavourable variances, but this is not always the case, because sometimes they will be negative.

Interpreting the components, we see that higher prices for labour and supplies accounted for almost 32% of the total variance. The “Resource Conversion Efficiency Variance(R)” suggests that the activity producing departments were less efficient than expected, and that this accounted for almost 24% of the total variance. In traditional accounting variance analysis the activity producing departments are the ones who see variance reports. In this example over 75% of the traditional accounting variance is beyond their influence, but they would never see that in a traditional report The Activity Utilization Variance (U) shows that 27% of the total variance is caused by a higher use of activities in treating the patients. This implies that the doctors actually prescribed more care for the patients than specified in the care maps, or utilization standards. The Product Mix Variance (m) shows that almost 15% of the cost overrun can be attributed to more patients being treated than had been planned.

The next part of FIG. 1B shows the Interaction Variance Components. In this case most of these are small, but three of them warrant comment because of an interesting pattern. The two-way interaction of Efficiency and Utilization (R, U) accounts for just over 5% of the total variance. However, the interactions of Efficiency and Product Mix (R, m) and Utilization and Product Mix (U, m) almost completely offset it, because they are negative, and add up to 4.65%

Note that the total of all of the Cost Variance Components adds up to $566,643.25, which is exactly the Total Cost Variance.

The Improvement to the Original Broyles and Lay Method According to the Present Invention

This method provides analysis of cost variances which arise when actual organizational activity levels differ from the planned or budgeted levels. Any organization which can employ the requisite costing techniques (such as activity-based costing, standard costing or other cost accounting approaches) can apply the process and can benefit from increased understanding of the impact of changes in prices, departmental efficiency, product content/utilization protocols (production protocols or bills of materials, or patient treatment protocols, or other similar protocols) and product mix and volumes.

An important consideration in managing any organization is how to determine what the revenue and expense budgets should be, and another is to find appropriate explanations for the causes when the actual revenues and spending differ from the budgets. The method identifies details of accounting variances from budgeted to actual cost and revenues, at the level of the entire organization, and at product/program management, service-production-department management levels and purchasing and personnel departments. The program, service-production-department, purchasing and personnel managers are then able to explain the causes of the components of the variance which lie within their domain of responsibility, and the causes of those which are outside their responsibility.

Application of the modified method is presented in the following series of examples.

### EXAMPLE 1

### Attributing Cost Variance to a Product or Product-Group within a Product Mix

In one embodiment, the method of the present invention is used to perform cost variance analysis at the product or product group dimension as follows. Much more detailed information than given in the original p′RUm model is possible, using the present invention. The first extension of the model requires turning the product mix vector into a diagonal matrix, where each product has its own column. (The vector m becomes diag(m), where values not on the diagonal are zeros. A variant of this puts all products that belong in a product-group into a single column. The resulting matrix is not a pure diagonal matrix, but the same formulas can be used, replacing diag(m) by group(m).)

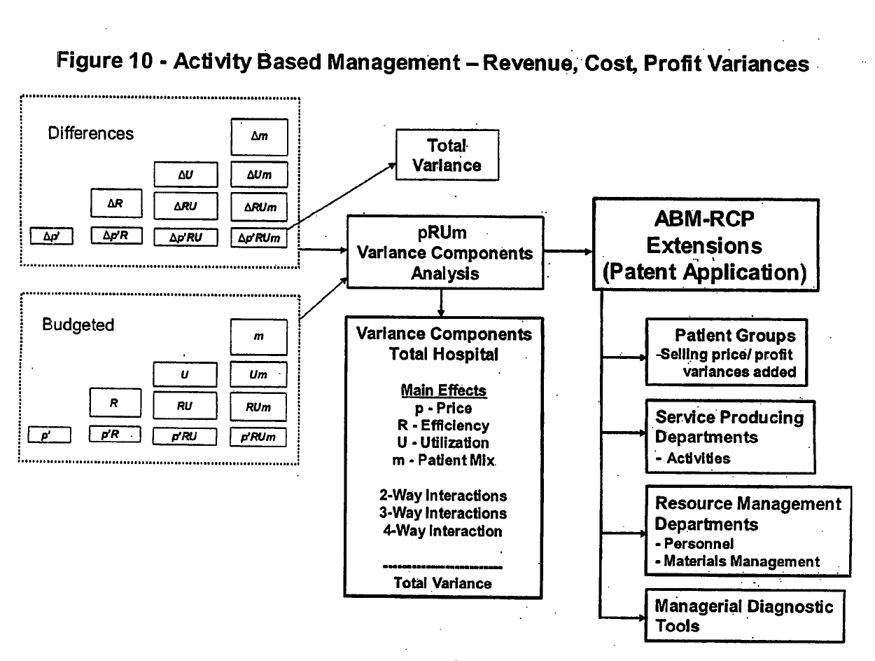

FIG. 10 shows elements of the original pRUm method and improvements according to the present invention. The Total Variance is the difference between Actual Total Costs and Budgeted Total Costs. This number would be the bottom line for a typical hospital. Did it have a surplus, break even, or run a deficit? The original pRUm method proposed a method of partitioning the causal components of that total variance into the main effects of the four causal factors and their two, three and four-way interactions. For the first time the hospital senior management could see what was causing their overall budget variances, if they had the requisite patient costing systems in place. The original pRUm method was not implemented across all departments of the hospital at a much more micro level.

FIG. 10 also shows the implementation of the ABM-RCP Variance Analytics improvement to the pRUm method according to the present invention. These extensions provide three complementary views of the variance components across the hospital, which are:
the Products (Treated Patients by Group)—both detailed and at various roll-up levels
the Services provided to the patients—both detailed, and rolled-up in departmental and functional centre groupings
the Resources employed in creating the services—both detailed labour and supplies and roll-ups of these

Each view is complete and accounts for the total variance of the hospital, but from its own viewpoint. There are no partial pictures; nothing is left out or ignored, and there is no double counting within a particular view. The required matrix manipulations are more complex than the overall hospital calculations, but lead to the same four main causal factors and their interactions. All the variance is accounted for, and each component is relevant to a particular manager or department or group. Furthermore, the various departmental managers are provided a tool which allows them to diagnose the detailed sources of the four main factors within their own area of responsibility.

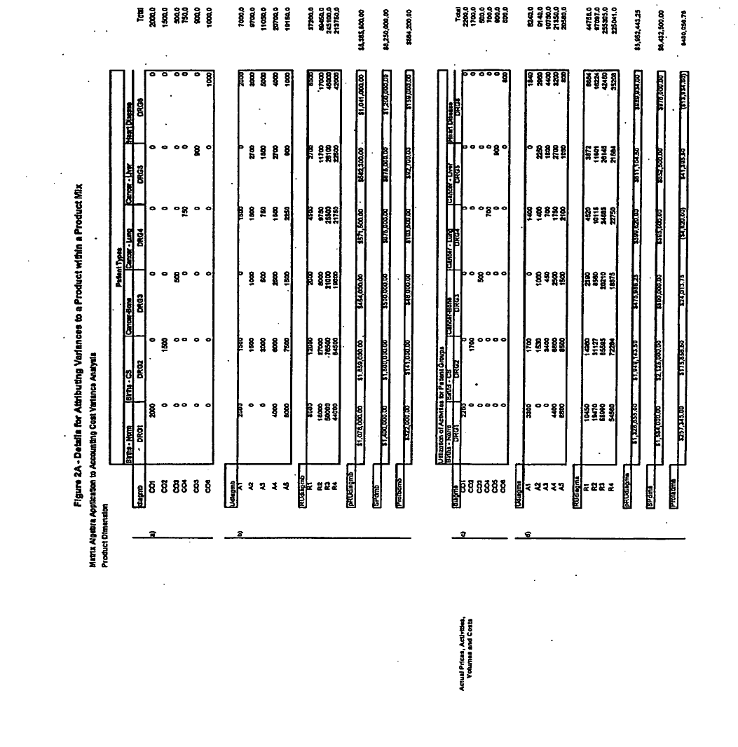

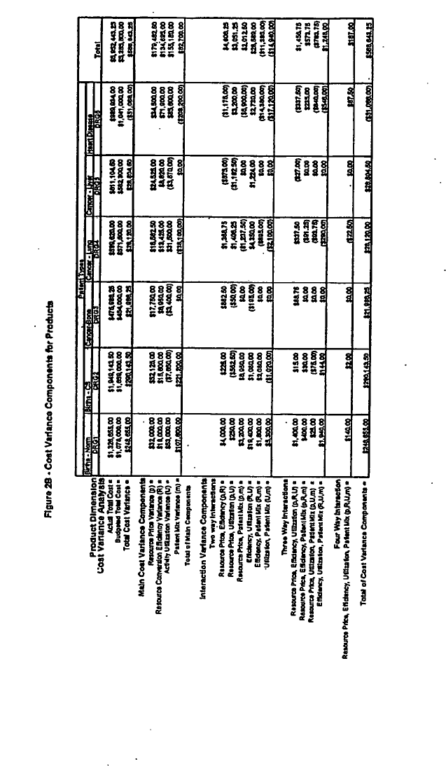

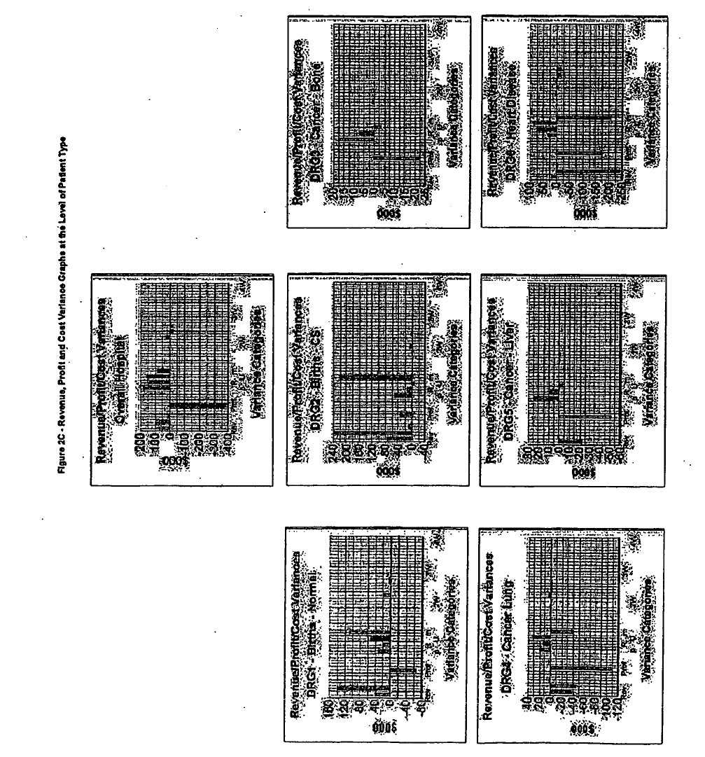

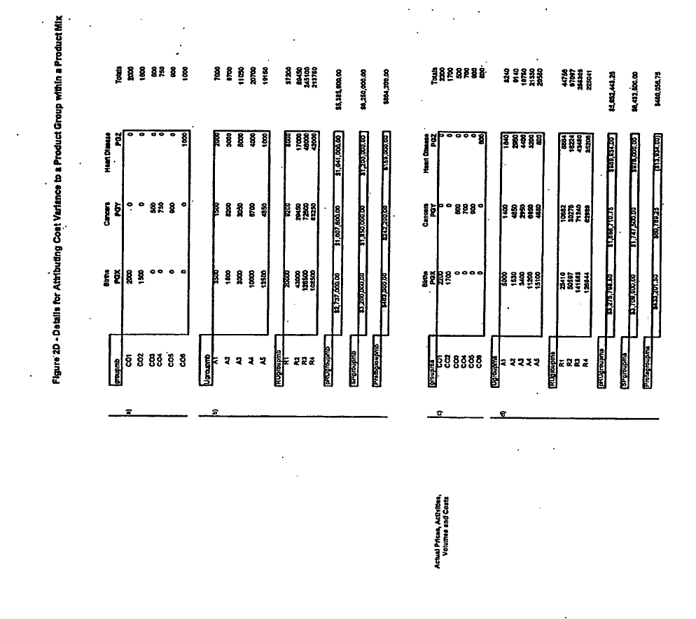

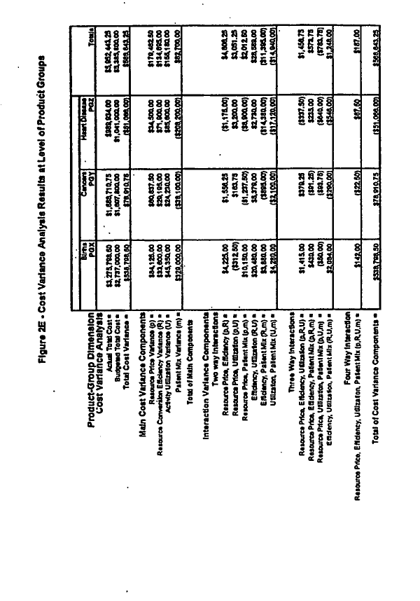

FIGS. 2A-2E present illustrations of a possible implementation of the method presented in Example 1 for a small hospital. FIG. 2A illustrates the diagonal matrices of the cost variance analysis for the product dimension according to the invention (segments a and c), and the intermediate matrix products (segments b and d) leading to FIG. 2B which illustrates the cost variance analysis for the product dimension. FIG. 2C illustrates a graphical presentation of the data from the columns of 2B and 5B (described below). FIG. 2D illustrates the grouped matrices of the cost variance analysis for the product-group dimension according to the invention (segments a and c), and the intermediate matrix products (segments b and d) leading to FIG. 2E, which illustrate the cost variance analysis for the product-group dimension.

According to the present invention, in the extended model of Example 1 the total cost variance becomes a vector of variances with one element giving the total variance for each product:
p′RU·diag(mₐ)−p′RU·diag(m_{b})

The sum of the elements of this vector is the total variance for the organization and is the same as:
p′RUmₐ−p′RUm_{b}

An important further step is to develop the cost variance analysis by product for the four main components and all the interactions. The product-specific main effect variance formulas become:
Price variance (p)=(p′ₐ−p′_{b})RU·diag(m_{b})
Efficiency variance (R)=p′_{b}(Rₐ−R_{b})U·diag(m_{b})
Utilization variance (U)=p′R_{b}(Uₐ−U_{b})·diag(_{mb})
Mix variance (m)=p′RU_{b}·diag(mₐ−m_{b})
each of which is a vector of variances with one element for each product.
The product-specific two-way interactions are:
   Price, Efficiency (p, R)=(p′ₐ−p′_{b})(Rₐ−R_{b})U·diag(m_{b})
   Price, Utilization (p, U)=(p′ₐ−p′_{b})R_{b}(Uₐ−U_{b})·diag(m_{b})
   Price, Mix (p, m)=(p′ₐ−p′_{b})RU_{b}·diag(mₐ−m_{b})
   Efficiency, Utilization (R, U)=p′_{b}(Rₐ−R_{b})(Uₐ−U_{b})·diag(m_{b})
   Efficiency, Mix (R, m)=p′_{b}(Rₐ−R_{b})U_{b}·diag(mₐ−m_{b})
   Utilization, Mix (U, m)=p′R_{b}(Uₐ−U_{b})·diag(mₐ−m_{b})
each of which is a vector of variances with one element for each product.
The product-specific three-way interactions are:
   Price, Efficiency, Utilization (p, R, U)=(p′ₐ−p′_{b})(Rₐ−R_{b})(Uₐ−U_{b})·diag(m_{b})
   Price, Efficiency, mix (p, R, m)=(p′ₐ−p′_{b})(Rₐ−R_{b})U_{b}·diag(mₐ−m_{b})
   Price, Utilization, mix (p, U,m)=(p′ₐ−p′_{b})R_{b}(Uₐ−U_{b})·diag(mₐ−m_{b})
   Efficiency, Utilization, mix (R, U, m)=p′_{b}(Rₐ−R_{b})(Uₐ−U_{b})·diag(mₐ−m_{b})
each of which is a vector of variances with one element for each product.
The product-specific four-way interaction is:
   Price, Efficiency, Utilization, mix (p, R, U, m)=(p′ₐ−p′_{b})(Rₐ−R_{b})(Uₐ−U_{b})·diag(mₐ−m_{b})
which is a vector of variances with one element for each product.

The sum of the four main components and all the interactions is a vector giving the total cost variance for each product, and is equal to:
p′RU·diag(mₐ)−p′RU·diag(m_{b})
and the sum of the elements of this vector is the total variance for the organization and is the same as:
p′RUmₐ−p′RUm_{b}

Products can be aggregated into product groups at various levels. For example, a microcomputer manufacturer could view product groups at a very macro level, such as desktop and laptop computers. They could also be interested in finer groups, such as desktop computers for home users, small business users, and large networked organizations. Any level of grouping desired can use the 16 formulas above, replacing diag(m) by group(m) and changing the language from “product” to “product group.”

In the previous hospital example, FIG. 2A shows the diagonalization of the Product (patient) mix vectors mb and ma, to give diagmb and diagma in the areas of the vertical bars marked “a)” and “c)”. The areas marked “b)” and “d)” show the results of multiplying Ub, RUb, p′RUb and spb times diagmb and Ua, RUa, p′RUa and spa times diagma respectively. Note that the totals column on the right-hand side is obtained by summing the rows, and is identical to the right hand column data in FIG. 1A, except that there are now detailed results for each type of patient, whereas previously the information was aggregated to the level of the whole hospital.

FIG. 2B shows p′RUm Cost Variance Analysis according to the present invention for the Product Dimension, with one column for each type of patient treated. The “Total” column on the right-hand side is obtained by summing the rows, and is identical to the right-hand column of the lower half of FIG. 1B.

Examining the columns of FIG. 2B reveals interesting information that was previously obscured by having the p′RUm analysis carried out only at the level of the total hospital. For example, the Total Cost Variance for patient type DRG6 (Heart Disease) is negative ($51,066), so it partially offsets the positive cost variances of patient types DRG1 to DRG5. However, this is not the end of the story. The negative $51,066 for DRG6 is the sum of all of the variance components below it in its column. Moving down this column reveals a mixture of large and moderately large variances, mostly negative, but some positive. The Product Mix Variance for DRG6 (heart patients) is extremely large and negative ($208,200). This means that there were fewer patients treated than planned, so that their total actual treatment cost was less than budgeted. Column DRG6 in FIG. 2A reveals that 1000 patients were planned, but only 800 actually treated, a 20% drop from the plan. If the hospital is being reimbursed on a patient-by-patient basis, this loss of patients also means a loss of revenue. If the hospital is on a global budget which is not sensitive to patient volumes in the short run, then fewer patients to treat means less stress on the budget.

Looking at the other three main cost variance components for the heart patients in DRG6 reveals more disturbing information. The Utilization variance (U) is $85,600, an over-expenditure. This means that, on average, the heart patients were receiving more care than called for in the care map. The efficiency variance is also positive at $71,900, so that the activities used in the treatment of the heart patients were more costly than planned. The resource price variance (p) is also positive, which means that the prices of the input resources went up. The sum of these three positive variances is $192,000, which is alnost equal in magnitude to the negative patient mix variance. Again the revenue/reimbursement situation may lead to different interpretations of the impact of these variances.

Looking at the two-way interaction variances for the heart patients (DRG6) reveals that the interactions of patient mix (m) with each of the other factors (p, R, and U) are negative, and very noticeable, although of lesser magnitude than the main variance components.

Overall, there seem to be a number of problems affecting the heart patients. Who has responsibility for managing these problems? Clearly, the doctors treating those patients have a great deal of control over the utilization variance (because they write the treatment orders), and they are responsible for admission decisions (although they cannot admit patients who do not ever look for treatment). What responsibility do the doctors have for the efficiency and price variances (R and p)?

Efficiency and price variances are the responsibility of other managers, but they have a significant impact on the apparent variance of this group of patients. The total cost variance for the heart patients is relatively small compared to some of the main cost variance components, because the positive and negative variances come dose to offsetting each other. The small total cost variance masks important variances that need to be understood and explained.

Similarly, looking across the rows of the cost variance analysis in FIG. 2B reveals important issues of positive and negative variances partially offsetting each other. The totals are not nearly so impressive as the individual components. This is particularly visible in the rows for Utilization and Mix. These findings raise issues for management to investigate to determine whether there are problems to be solved or opportunities to be exploited.

It is often useful to show data, such as that in FIG. 2B, in a graphical form rather than a tabular form. FIG. 2C shows such a presentation of cost variances at the level of patient types. Each column of FIG. 2B generates one graph in FIG. 2C (with the addition of revenue and profit variances, which are discussed later). The vertical bars represent the variances, and they progress from left to right. Reference is now made to the four bars representing the main cost variance components (p, R, U, and m).

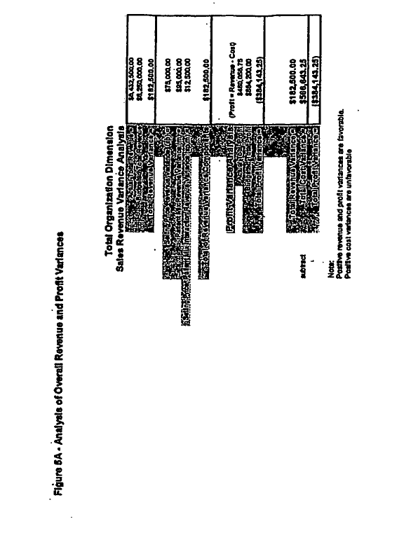

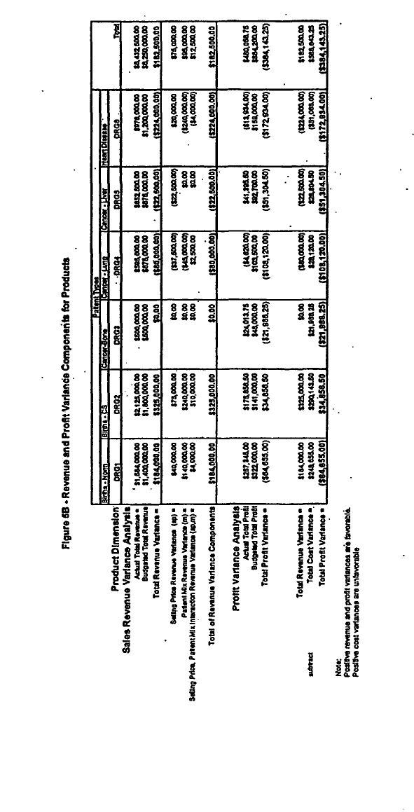

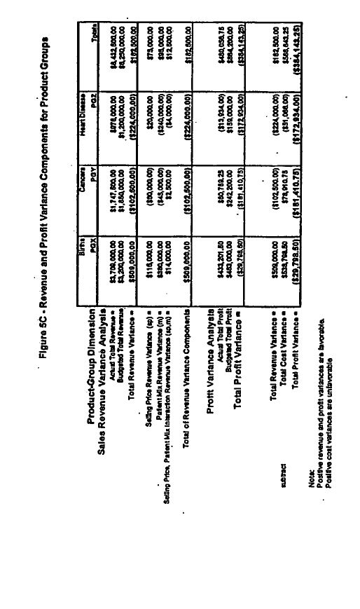

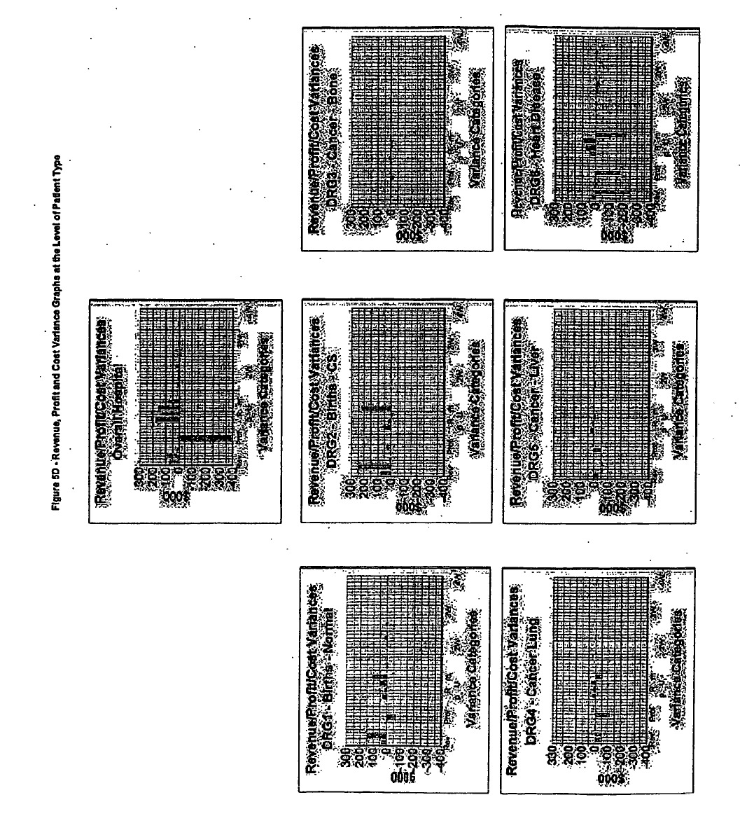

Each of the six DRG (Patient Type) graphs shows a different pattern of positive and negative bars. Consider DRG6 and DRG2. Their patient mix (m) bars are opposite in direction and have approximately the same magnitude. Their utilization (U) bars point in opposite directions but have very different magnitudes. This suggests rather different management problems for doctors treating these patients. The other four Patient Types also show different price changes (p) and activity producing department efficiency (R). Finally, it should be noted, the vertical scale is different in each case. FIG. 5D shows the same graphs with a common vertical scale, to show the comparative importance of the variances for each patient type.

These variances at the level of the Product Group, potentially much higher level of aggregation, which would be of interest to senior levels of management. In this example the structure of the six patient types consists of 2 types of deliveries (births), 3 types of cancers, and heart disease. They can also be called Program X, Program Y and Program Z.

FIG. 2D shows the grouped matrices for the budgeted and actual numbers of patients, and FIG. 2E shows the cost variance components at the level of the program groups. Comparing region “a” of FIG. 2D to the equivalent region of FIG. 2A, reveals that the two columns of births have been combined into one, as have the three columns of cancers. Looking at each matrix in 2D reveals that each column is the sum of the corresponding columns in 2A. Looking at the cost variance analysis in 2E reveals a similar comparison with 2B, in that the columns of 2B have been summed to get the corresponding column of 2E. A graphical version of this data is not presented, but could easily be.

### EXAMPLE 2

### Cost Variance Analysis at the Activity and Activity-Producing Department Dimension

The present invention can be extended in a different direction, namely to allow the diagnosis of the efficiency of operation of the activity-producing departments by focusing on the resources used and activities produced by individual departments. A common complaint of departmental managers is that they should not be held accountable for factors beyond their control, namely the variations in the volume of activities they are called upon to produce because of decisions of product managers, or variations in the prices of the input resources.

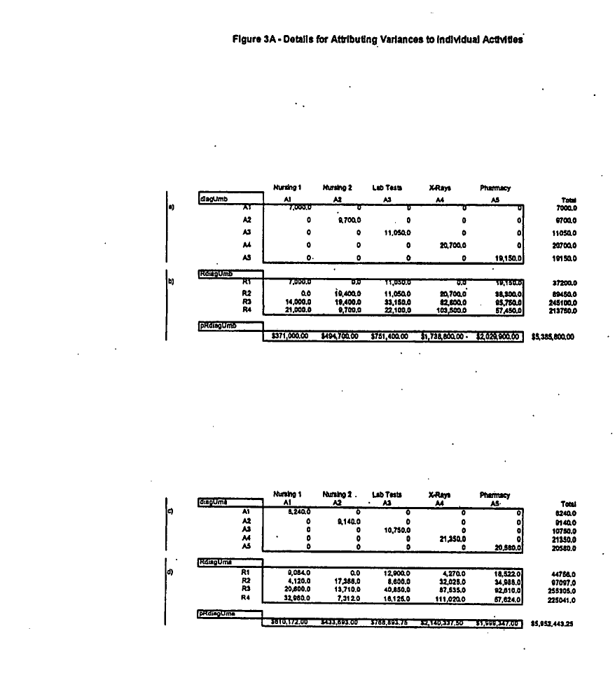

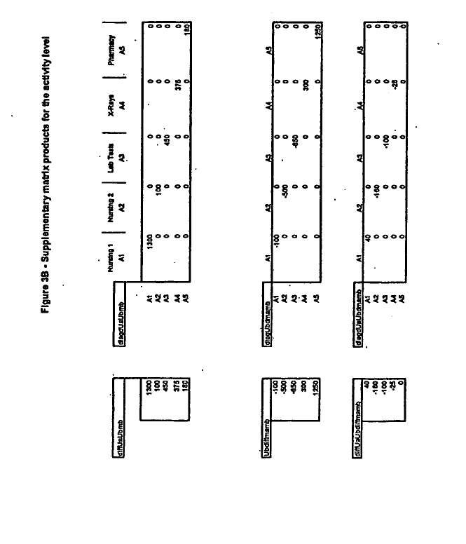

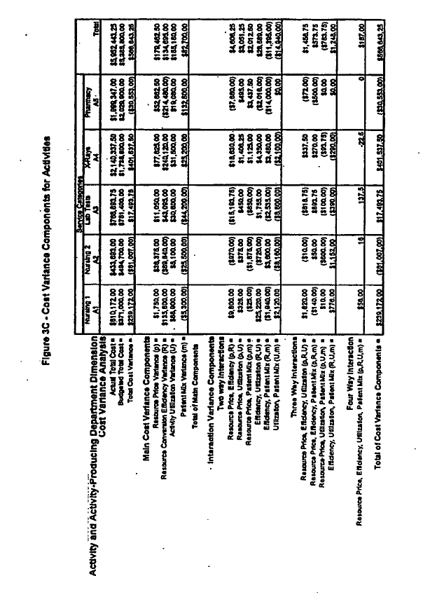

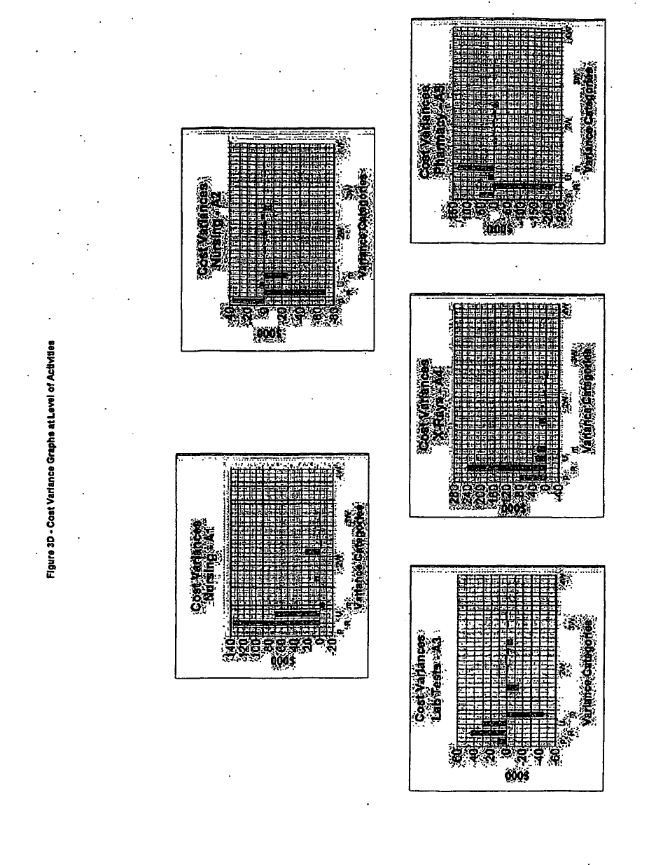

FIGS. 3A-3D present illustrations of a possible implementation of the method presented in Example 2. FIG. 3A illustrates the diagonal matrices of the cost variance analysis for the product dimension according to the invention (segments a and c), and intermediate matrix products (segments b and d). FIG. 3B illustrates further intermediate diagonalized matrices required by the method. FIGS. 3A and 3B lead to FIG. 3C which illustrates the cost variance analysis for the activity dimension, and to FIG. 3D which presents the data columns of FIG. 3C in graphical form. The activity-producing-department dimension analysis utilizing grouped matrices could be illustrated as an extension of FIGS. 3A and 3B, in a manner analogous to FIG. 2E.

A variance analysis which shows the impact of efficiency, prices, utilization profiles and product mix on the operation of activity-producing departments requires combining the effects of product manager decisions about U and m to obtain the volume of activities or services demanded, Um. This is a column vector of activities showing the volumes the departments are expected to produce. The budgeted and actual values are given by the column vectors UM_{b} and Umₐ.

The second extension of the original p′RUm model is to diagonalize these vectors to obtain the matrices diag(UM_{b}) and diag(Umₐ). Each column is specific to a particular activity and gives the volume of activities required for the production of all products. Pre-multiplying by R gives the “Resources by Activities” matrices, R·diag(Um_{b}) and R·diag(Umₐ), which indicate the resources required for carrying out each of the types of activities at the levels required for the production of all products. Pre-multiplying those matrices by p′ gives the “Dollars by Activities” vectors p′R·diag(Um_{b}) and p′R·diag(Umₐ). These are vectors which indicate the dollars required for producing each type of service at the budgeted and actual levels required for the production of all products.

A variant of this puts all activities that belong in a department (or organizational unit at whatever level) into a single column. The resulting matrix is not a pure diagonal matrix, but the same formulas can be used, replacing diag(Um) by group(Um), and each other “diag” by the corresponding “group.”

In the second extension of the model the total cost variance becomes a vector of variances with one element giving the total variance for each activity:
p′R·diag(Umₐ)−p′R·diag(Um_{b})

The sum of the elements of this vector is the total variance for the organization and is the same as:
p′RUmₐ−p′RUm_{b}

An important further step is to develop the cost variance analysis for the four main components and all the interactions. The activity-specific main effect variance formulas become:
Price variance (p)=(p′ₐ−p′_{b})R·diag(Um_{b})
Efficiency variance (R)=p′_{b}(Rₐ−R_{b})·diag(Um_{b})
Utilization variance (U)=p′R_{b}·diag((Uₐ−U_{b})m_{b})
Mix variance (m)=p′R_{b}·diag(U_{b}(mₐ−m_{b}))
The activity-specific two-way interactions are:
   Price, Efficiency (p, R)=(p′ₐ−p′_{b})(Rₐ−R_{b})·diag(Um_{b})
   Price, Utilization (p, U)=(p′ₐ−p′_{b})R_{b}·diag((Uₐ−U_{b})m_{b})
   Price, Mix (p, m)=(p′ₐ−p′_{b})R_{b}·diag(U_{b}(mₐ−m_{b}))
   Efficiency, Utilization (R, U)=p′_{b}(Rₐ−R_{b})·diag((Uₐ−U_{b})m_{b})
   Efficiency, Mix (R, m)=p′_{b}(Rₐ−R_{b})·diag(U_{b}(mₐ−m_{b}))
   Utilization, Mix (U, m)=p′R_{b}·diag((Uₐ−U_{b})(mₐ−m_{b}))
The activity-specific three-way interactions are:
   Price, Efficiency, Utilization (p, R, U)=(p′ₐ−p′_{b})(Rₐ−R_{b})·diag((Uₐ−U_{b})m_{b})
   Price, Efficiency, Mix (p, R, m)=(p′ₐ−p′_{b})(Rₐ−R_{b})·diag(U_{b}(mₐ−m_{b}))
   Price, Utilization, mix (p, U,m)=(p′ₐ−p′_{b})R_{b}·diag((Uₐ−U_{b})(mₐ−m_{b}))
   Efficiency, Utilization, Mix (R, U, m)=p′_{b}(Rₐ−R_{b})·diag((Uₐ−U_{b})(mₐ−m_{b}))
The activity-specific four-way interaction is:
   Price, Efficiency, Utilization, Mix (p, R, U, m)=(p′ₐ−p′_{b})(Rₐ−R_{b})·diag((Uₐ−U_{b})(mₐ−m_{b}))

Any level of grouping desired can use the formulas above, replacing each “diag” by “group” and changing the language from “activity” to “activity-producing department.”

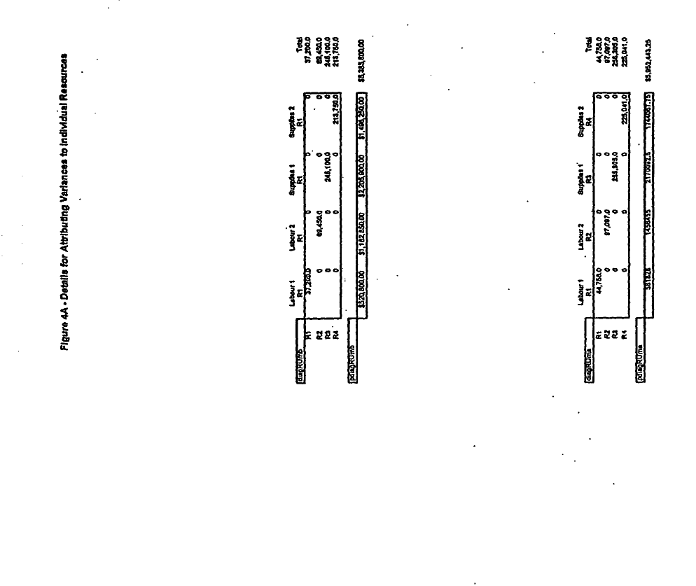

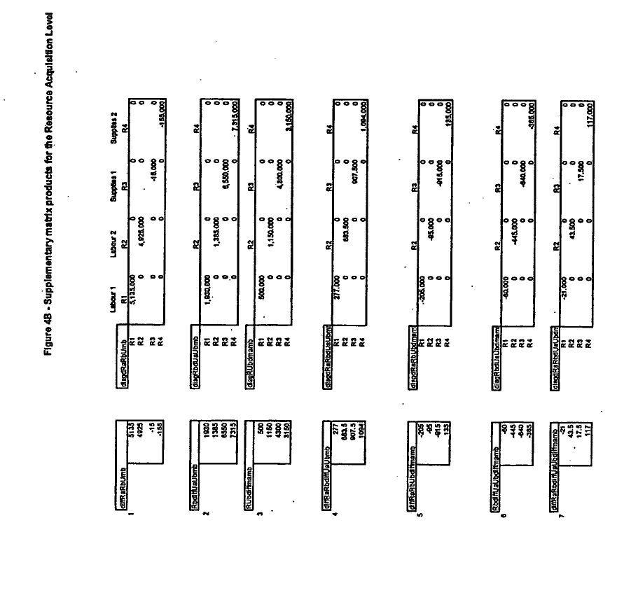

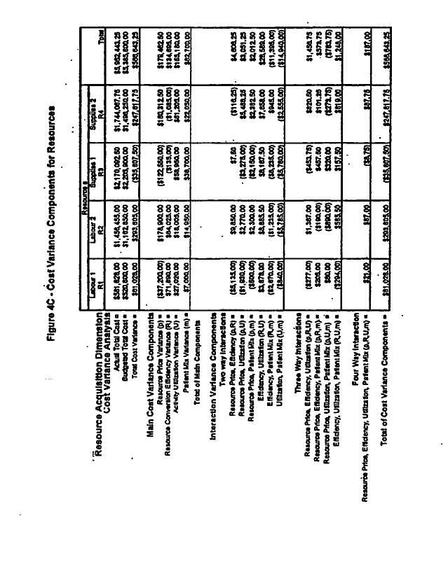

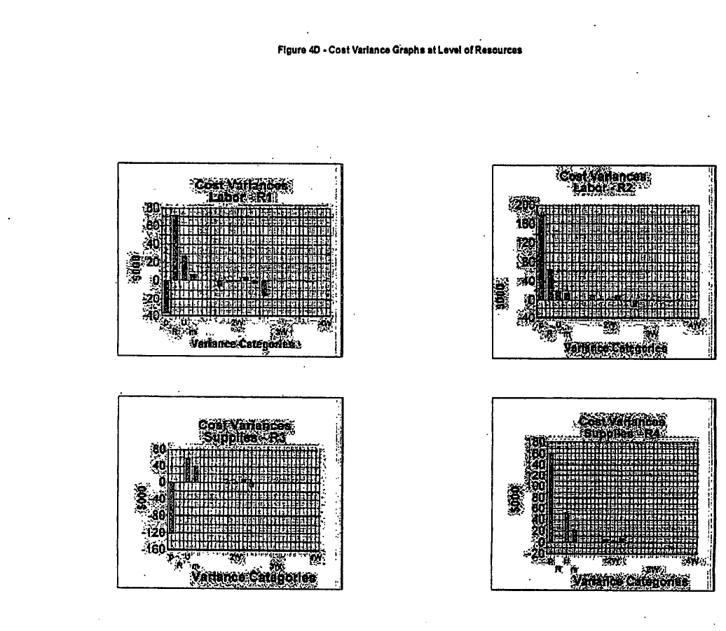

FIG. 3A shows the diagonalization of the Um products for the budgeted and actual values in areas “a” and “c”. It is useful to compare each of FIGS. 1A, 2A and 3A to see the pattern which develops, and which follows through to FIG. 4A in the next section. In FIG. 3A the Patient Mix vector has been pre-multiplied by the Utilization matrix, with the result that they are coalesced with each other into a single vector which is then diagonalized. Notice that the totals in the right-hand column are identical to the equivalent parts of FIG. 1A. FIG. 3B presents a series of supplementary matrix products required to implement the equations of the method.

FIG. 3C presents the cost variance analysis for the level of activities, and 3D presents the graphs. Notice that there are 5 activities, while there are 6 patient types. This means that the cost variance components for activities have only 5 columns, while FIG. 2B had 6 columns of cost variance components for patient types. However, the totals columns are identical to each other and to the cost variance components in the equivalent part of FIG. 1B. The cost variance analysis for each viewpoint presents the same total, so that the distinction is that the different managers see things from their own perspective. The doctors treat patients who receive services from all the different activities. From their perspective the activity managers provide services to all different types of patients. In general, there will not be the same number of kinds of activities as there are types of patients. However, all patients, taken as a group, must use all the services that are provided by the activity departments.

This is an important point about this ABM Variance Analytics procedure. Each group of managers sees the totality of the variance, but from their own point of view. Unlike special studies where components of cost often are left out inadvertently, there is nothing left out in ABM-RCP.

Another important point is that each group of managers can focus on those variance components that are truly their own responsibility. The doctors will look at the U and m variance components primarily, since those are their responsibility. The activity managers will focus their attention on the R component in FIG. 3C, since that reflects the efficiency of their operations. They can see what impact they have felt from the decisions of the doctors, and of the purchasing and personnel managers, but they are responsible only for their own decisions.

When the main variance component for activity efficiency (R) is examined, as before, there are components that are positive, and others that are negative. The positive cost variances reflect inefficiency, while the negative ones reflect more efficient operations than expected. It is interesting to note that the total for R is $134,695 but that there are certain components which are much larger, both positive and negative. The managers of the various activities will have to study their own results to see whether there are lessons to be learned.

Where would they look for the lessons that are indicated by these numbers? One place to start is in the simple matrix of differences (diffRaRb) in FIG. 1B. Note that for Activity A5 (Pharmacy) there is a string of small negative numbers. These suggest that the pharmacy was more efficient in its use of all resourves in producing its service activities. The numbers seem small, but are actually in the range of 10% to 15%. When multiplied by all the times that those pharmaceutical services are used in the treatment of patients, the impact is very large.

### EXAMPLE 3

### Cost Variance Analysis at the Resource Acquisition Dimension

A variance analysis which shows the impact of efficiency, prices, utilization profiles and product mix on the operation of resource-acquisition departments requires combining the effects of activity-producing department manager and product manager decisions about R, U and m to obtain the volume of resources required, RUm. This is a column vector of resources showing the volumes of resources required. The budgeted and actual values are given by the column vectors RUm_{b} and RUmₐ.

The third extension of the original p′RUm model is to diagonalize these vectors to obtain the matrices diag(RUm_{b}) and diag(RUmₐ). Each column is specific to a particular resource and gives the volume of resources required for all activities for the production of all products. Premultiplying those matrices by p′ gives the “Dollars for Resources” vectors p′·diag(RUm_{b}) and p′·diag(RUmₐ). These are vectors which indicate the dollars required for acquiring each type of resource at the budgeted and actual levels required for all activities for the production of all products.

A variant of this puts all resources acquired by a purchasing or personnel department (or organizational unit at whatever level) into a single column. The resulting matrix is not a pure diagonal matrix, but the same formulas can be used, replacing each “diag” by “group.” Note that there could be more than one purchasing department, and more than one unit responsible for hiring and/or contract negotiations in a given organization, or sub-units of either of these types of departments.

FIGS. 4A-4D present illustrations of a possible implementation of the method presented in Example 3. FIG. 4A illustrates the diagonal matrices of the cost variance analysis for the resource acquisition dimension according to the invention (segments a and c), and intermediate matrix products (segments b and d). FIG. 4B illustrates further intermediate diagonalized matrices required by the method. FIGS. 4A and 4B lead to FIG. 4C which illustrates the cost variance analysis for the resource acquisition dimension, and to FIG. 4D which presents the data columns of FIG. 4C in graphical form. The resource-acquisition-department dimension analysis utilizing grouped matrices could be illustrated as an extension of FIGS. 4A and 4B, in a manner analogous to FIG. 2E.

In the third extension of the model the total cost variance becomes a vector of variances with one element giving the total variance for each resource:
p′·diag(RUmₐ)−p′·diag(RUm_{b})

The sum of the elements of this vector is the total variance for the organization and is the same as:
p′RUmₐ−pRUM_{b}

An important further step is to develop the cost variance analysis for the four main components and all the interactions. The resource-acquisition-specific main effect variance formulas become:
Price variance (p)=(p′ₐ−p′_{b})·diag(RUm_{b})
Efficiency variance (R)=p′_{b}·diag((Rₐ−R_{b})Um_{b})
Utilization variance (U)=p′_{b}·diag(R_{b}(Uₐ−U_{b})m_{b})
Mix variance (m)=p′_{b}·diag(RU_{b}(mₐ−m_{b}))
The resource-acquisition-specific two-way interactions are:
   Price, Efficiency (p, R)=(p′ₐ−p′_{b})·diag((Rₐ−R_{b})Um_{b})
   Price, Utilization (p, U)=(p′ₐ−p′_{b})·diag(R_{b}(Uₐ−U_{b})m_{b})
   Price, Mix (p, m)=(p′ₐ−p′_{b})·diag(RU_{b}(mₐ−m_{b}))
   Efficiency, Utilization (R, U)=p′_{b}·diag((Rₐ−R_{b})(Uₐ−U_{b})m_{b})
   Efficiency, Mix (R, m)=p′_{b}·diag((Rₐ−R_{b})U_{b}(mₐ−m_{b}))
   Utilization, Mix (U, m)=p′_{b}·diag(R_{b}(Uₐ−U_{b})(mₐ−m_{b}))
The resource-acquisition-specific three-way interactions are:
   Price, Efficiency, Utilization (p, R, U)=(p′ₐ−p′_{b})·diag((Rₐ−R_{b})(Uₐ−U_{b})m_{b})
   Price, Efficiency, Mix (p, R, m)=(p′ₐ−p′_{b})·diag((Rₐ−R_{b})U_{b}(mₐ−m_{b}))
   Price, Utilization, mix (p, U,m)=(p′ₐ−p′_{b})·diag((R_{b}(Uₐ−U_{b})(mₐ−m_{b}))
   Efficiency, Utilization, Mix (R, U, m)=p′_{b}·diag((Rₐ−R_{b})(Uₐ−U_{b})(mₐ−mb))
The resource-acquisition-specific four-way interaction is:
   Price, Efficiency, Utilization, Mix (p, R, U, m)=(p′ₐ−p′_{b})·diag((Rₐ−R_{b})(Uₐ−U_{b})(mₐ−m_{b}))

Any level of grouping desired can use the formulas above, replacing each “diag” by “group” and changing the language from “resource acquisition” to “resource acquisition department.”

FIG. 4A presents the diagonalization of the RUm product, for which the size is given by the number of kinds of resources acquired and used by the hospital. (In one large hospital known to the authors, there are over 250,000 different items stocked in their inventory, so in a real situation the matrix diagRUmb in FIG. 4A can be very large!) FIGS. 4B-4D present the working out, and graphical presentation, of the cost variance analysis for the level of resource acquisition. The resource managers (personnel and purchasing) would focus on their own area of responsibility to see what impact their decisions have had on the operation of the hospital. They can neither claim credit for, or be blamed for, variances resulting from the actions of other managers. Comparing the price variance line of FIG. 4C to the basic data for the prices of the labour and supplies in FIGS. 1A and 1B leads to some interesting conclusions about the impact of apparently small changes in the wage rates for certain categories of employees, or in the purchase price of supplies. It is interesting that we again see that large negative and positive variances, shown in the price variance row (p) of FIG. 4C, nearly offset each other, so that the total price variance of $179,462.50 masks some large variances for individual resources.

### EXAMPLE 4

### Revenue and Profit Variance Analysis

Extension of the pRUm cost variance analysis to look at revenue and profit variances requires the addition of two vectors of Selling Prices for the cost objects (products), for both budgeted prices, sp_{b}, and actual prices, spₐ. Multiplication of each of these by their respective product mix vectors, m_{b} and mₐ, gives the budgeted and actual revenues.
Budgeted Revenue=sp_{b} m_{b}
Actual Revenue=spₐ mₐ
and the profits are derived by subtraction:
Budgeted Profit=sp_{b} m_{b}−pRUm_{b}
Actual Profit=spₐ mₐ−pRUmₐ

The variances are, again, actual-budgeted values, so that
Revenue Variance=spₐ mₐ−sp_{b} m_{b}
and
Profit Variance=spₐ mₐ−pRUmₐ−(sp_{b} m_{b}−pRUm_{b})

It is useful to further analyze the Revenue Variance, but not the Profit Variance, since the latter only duplicates the cost variance analysis previously developed, without adding new information.

The Revenue variance has two main components, Selling Price and Product Mix, and their interaction.
Selling Price Revenue Variance=(spₐ−sp_{b})m_{b}
Product Mix Revenue Variance=sp_{b}(mₐ−m_{b})
and their interaction
Selling Price, Product Mix Interaction Revenue Variance=(spₐ−sp_{b})(mₐ−m_{b})

Attached are examples of the tabular and graphical formats of one version of output from this model (a spreadsheet version accompanies this text).

As was stated earlier in the discussion of FIG. 1A, “The budgeted and actual selling price/Revenue are labeled spb and spa, and when these vectors are multiplied by the Mix of Cost Objects, mb and ma, the products spmb and spma are the total budgeted and actual patient revenue. Subtracting, Revenue minus cost, gives profit, both unit profit Profb and Profa and total profit Profmb and Profma. Again these are budgeted and actual values.”

FIG. 5A brings forward the values of revenue and profit, and subtracts, showing a revenue variance of $182,500 (favourable), and a profit variance of −$384,143.25 (unfavourable) for the hospital overall. Note that the Selling Price and Product Mix Revenue Variances, and their interaction, are all positive, meaning that revenues were higher than budgeted, a favourable situation. In this example, even although the revenue was higher than expected, the total costs were higher still with a total cost variance of $566,643.25, leading to the negative profit variance of −$384,143.25. This reflects the fact that the Actual Total Profit was lower than the Budgeted Total Profit.

FIG. 5B shows the details of the Revenue and Profit Variances by patient type. As suggested in an earlier discussion, there is a problem with the revenues and profits attributable to the heart patients. The actual volume of 800 patients was 20% lower than the budgeted volume of 1000 patients. At a budgeted reimbursement rate (selling price) of $1200/patient this leads to a patient mix revenue variance of −$240,000 (ie. −200×$1200). However, the actual reimbursement rate of $1220/patient was 1.66% higher than budgeted, and this led to a small positive selling price revenue variance of $20,000, and a negative interaction of $4,000 between selling price and product mix revenue variance. Note the different patterns of Revenue Variances across the three types of cancer patients, and the two types of births. In terms of revenue variances, the births have saved the day for the hospital, leading to a positive revenue variance overall.

However, shifting attention to the Profit Variances, suggests that the situation is less rosy. Only the second type of births show a positive profit variance, and the overall profit variance is −$384,143.25. This does not mean that there were no profits, only that the profits were substantially lower than expected.

FIG. 5C shows the consolidation of the patient types into the three care programs previously mentioned. It can be seen that the Obstetrics program (PGX) has the best performance, both for revenues and profits. It had an actual total revenue of $3,709,000, an increase of $509,000 over the budgeted amount. Although its profit variance was −$29,798.50 it had an actual profit of $433,201.50, a decrease from the budgeted amount. The Cancer and Heart Disease programs show an interesting crossover effect for their revenue and profit variances, all of which are negative. Compared to the Heart treatment program the Cancer program has a smaller drop in revenue, but a larger drop in profits. However, the Cancer treatment program still has a positive profit of $60,789.25, while the Heart Disease Program shows a loss of $13,934.

For senior management information of the level presented in FIG. 5C would provide a useful overview of problem areas in the hospital, but FIG. 5B gives important details that are obscured by a summary level of presentation. For example, the Obstetrics program profit variance of −$29,798.50 obscures the detail that the first type of Births (DRG1) has a negative variance of $64,655 while the second type of Births (DRG2) has a profit increase of $34,856.50 compared to their budgets. An important management question would be “Why such a difference for similar types of patients?” The answer is found by examining differences in their product mix revenue variances, and total cost variances.

The DRG2 patient mix revenue variance is substantially higher than that for DRG1. Their total cost variances are doser to each other, but DRG2 is higher, at $290,143.50. Examining cost variances for Births type DRG2 in FIG. 2B we see that the product mix cost variance is $221,200, while the patient mix revenue variance is $240,000. Most of the increased revenue associated with the increase in volume is swallowed up by a corresponding increase in the total cost of treatment. The biggest reason for the difference between DRG1 and DRG2 types of Births is found in the difference between their Activity Utilization cost variances. The DRG1 patients had a Utilization cost variance of $53,000 (unfavourable) while the DRG2 patients had a Utilization variance of −$7,650 (favourable).

FIG. 5D reproduces FIG. 2C with an important change. The scales of the Y-axes have all been set to the same values so that the graphs are visually comparable. The overall profit variance of nearly −$400,000 is seen in the top graph. The largest single profit variance is the other Birth (DRG2). The largest positive Patient Mix Revenue Variance is that for DRG2, and the most negative is that for Heart Disease Patients (DRG6).

### EXAMPLE 5

### Detailed Reports for Activity and Product Managers

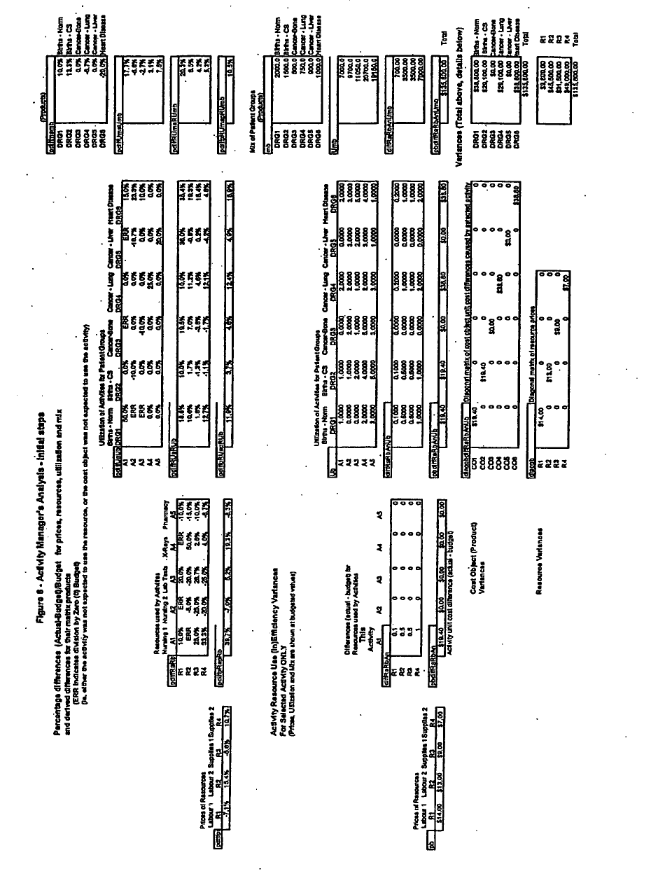

In another embodiment of the invention, FIG. 6 illustrates the initial steps of performing a detailed analysis of the impact of activity efficiency changes on the products (DRGs or other patient types) and resources. The method is similar to those previously described, with the following differences. The differences between actual and budgeted data originally illustrated in FIG. 1B are presented in the top half of FIG. 6 as percentage changes. The cells marked “ERR” represent division by zero, because the budgeted figure was zero. This is also conventionally called “infinity” or an “infinite” change. The bottom half of FIG. 6 illustrates a change from the presentations of FIG. 1A, in that the pb, Ub and mb vectors and matrix are all at budget values, but Rb has been replaced by a matrix consisting only of 1 column of differences from Rab (from FIG. 1B) and the rest of the columns being zeros, and now designated diffRaRbAn, where n represents the selected column. The product of pb and diffRaRbAn gives pbdiffRaRbAn, the activity unit cost difference for the selected activity. Carrying through the other multiplications gives results which depend only on the changes in efficiency of the selected activity. In particular, the row vector pbdiffRaRbAnUb represents the difference in unit costs of the products (patient types) caused only by the changes in the efficiency of the selected activity. Note that these differences appear wherever the selected activity participates in the services provided to the patients of a particular type.

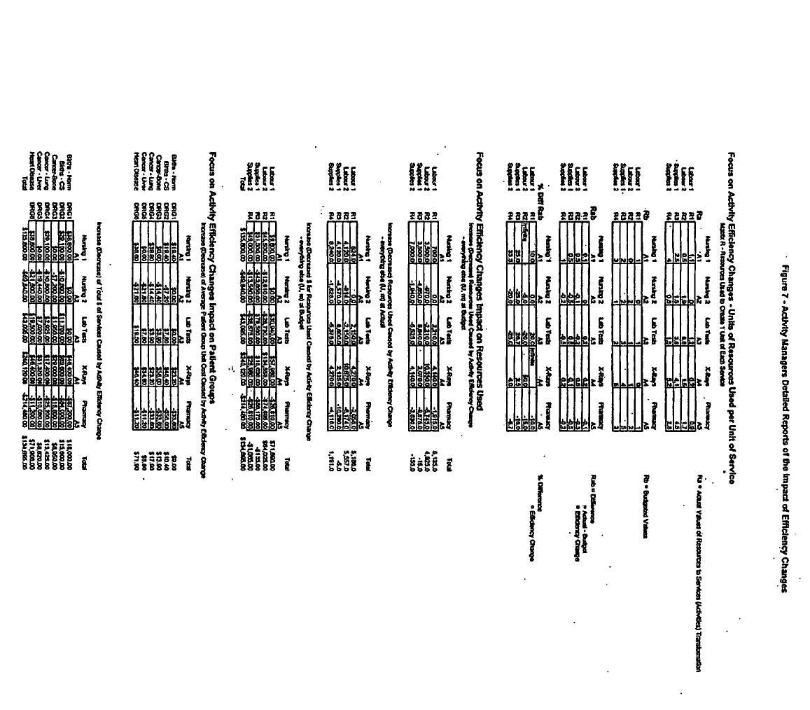

The vectors pbdiffRaRbAn and pbdiffRaRbAnUb are both diagonalized for the next steps of the method. The product of diagpbdiffRaRbAnUb and mb gives the total change of costs for each product (patient type) attributable only to the changes in the efficiency of the selected activity, and this is shown on the right hand side towards the bottom of FIG. 6. This vector is copied into a relevant table in FIG. 7.

The product of diagpbdiffRaRbAn with Ub and mb gives the total change in costs of resources attributable only to the changes in the efficiency of the selected activity, and this is shown on the right hand side at the bottom of FIG. 6. This vector is also copied into a relevant table in FIG. 7.

These steps are repeated iteratively, once for each activity. In the spreadsheet this has been done manually, but this could be accomplished automatically by various programming techniques, and has specifically been programmed in a companion program (not illustrated) in the language J.

FIG. 7 illustrates, by way of example only, some of the information that could be presented to activity managers to assist them in diagnosing the changes that have arisen throughout the organization attributable only to the changes in the efficiency with which their activities have been accomplished. These include, first, the basic R matrices and their changes.

Second, the impact on resource utilization throughout the organization (hospital), both in units of each resource and the dollar impact. It is a significant feature of this method that the dollar impact total row is identical to the “Resource Conversion Efficiency Variance (R)” row of FIG. 3C, which deals with the Cost Variance Components for Activities. Similarly, the right hand total column is identical to the “Resource Conversion Efficiency Variance (R)” row of FIG. 4C, which deals with the Cost Variance Components for Resources. Thus this table in FIG. 7 provides the detailed breakdown of the components of variance that are under the sole control of the activity managers, and assists them in deciding what corrective actions might be warranted, if the variances are unfavourable. It is worth noting once more that positive and negative variances may partially offset each other, and give a total which masks much more significant components.

Third, in FIG. 7, the last two tables give the “Activity Efficiency Changes Impact on Patient Groups.” One table shows the impact on the unit cost of treatment of each patient type (DRG1 to 6) of the changes in the efficiency of each activity relevant to the treatment of that type of patient. The total column on the right hand side gives the net impact on the unit cost of the treatment of each patient type. The bottom table shows the total dollar impact. As in the preceding paragraph, the total row relates to FIG. 3C, while the total column relates to FIG. 2C, Cost Variance Components for Products, in particular the “Resource Conversion Efficiency Variance (R)” row, and is identical.

Thus, FIG. 7 provides a wealth of information for activity managers that was hitherto unavailable, and should enable much more precise diagnosis of causes of variances, and their impact on various parts of the organization.

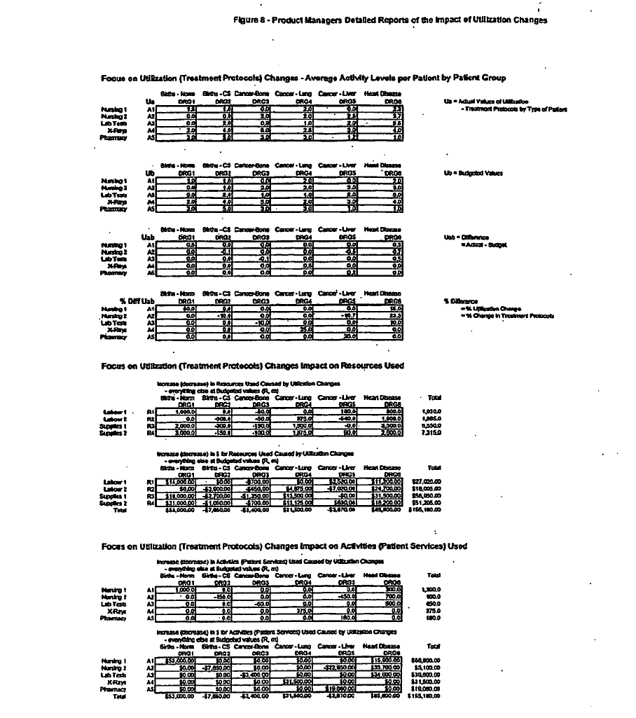

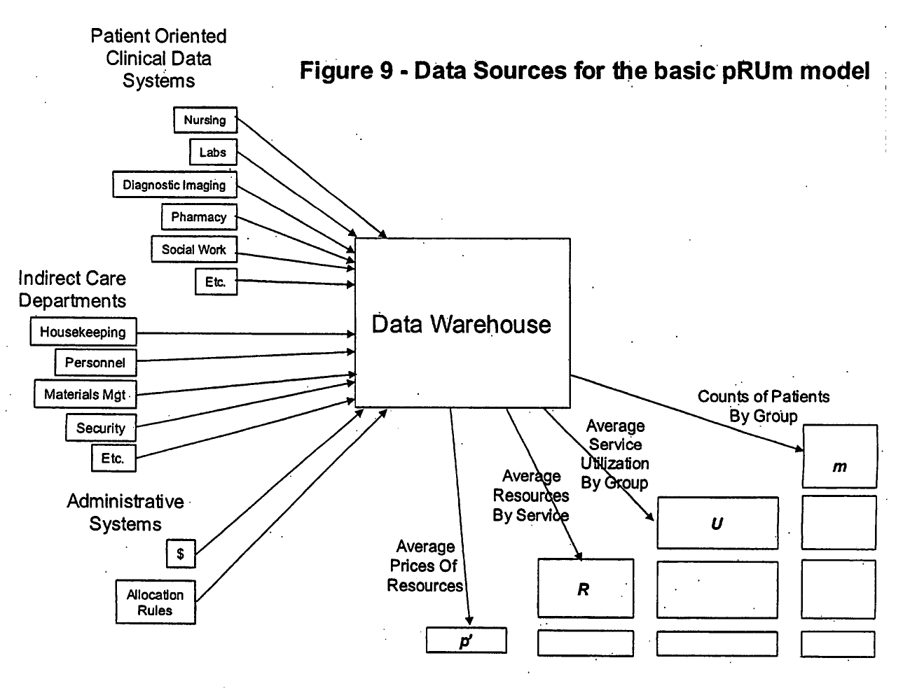

FIG. 8 presents the results of analogous methods applied to the analysis of the impact of changes in the utilization matrices Uₐ and U_{b}. The results as presented, show the product managers (doctors) the results of their decisions about the methods of treatment of patients, both in units and total dollars. In this case, the total dollar impact relates to the “Activity Utilization Variance (U)” row in FIGS. 2B, 3C and 4C, in the same way as mentioned in the immediately preceding paragraphs.

### Implications for Management

These extensions of the p′RUm model increase the power of accounting variance analysis to enable much more precise diagnosis of cost, revenue and profit variances. The groups with the most potential for controlling variances are given a tool which separates their areas of responsibility from those of other groups. Thus departmental managers and product managers can clearly differentiate the impact of their own decisions and actions on the costs of their own departments and the organization as a whole.

The above-described embodiments of the invention are intended to be examples of the present invention. Alterations, modifications and variations may be effected in the particular embodiments by those of skill in the art, without departing from the scope of the invention which is defined solely by the claims appended hereto.

In particular, altering the definition of the calculation of a variance from “actual minus budgeted” to “budgeted minus actual” does not depart from the scope of the invention.

1. A method of cost variance analysis, comprising;
(a) assessing variables p (price), R (efficiency), U (utilization) and m (product mix), at least one of the variables being a variable of interests comprising a plurality of influencing factors;
(b) expressing the variable of interest as a matrix having a plurality of columns, each column representing an influencing factor; and
(c) conducting p′RUm analysis according to Broyles and Lay, substituting the matrix for the variable of interest.

2. A method according to claim 1, including the step of assessing the impact of an influencing factor on cost variance attributable to the variable of interest.

3. (canceled)

4. (canceled)

5. (canceled)

6. (canceled)

7. A method according to claim 1, including the step of combining the variables U (utilization) and m (product mix), to obtain the variable of interest Um which represents volume of services.

8. A method according to claim 1, wherein the matrix is a diagonal matrix and each column of the matrix represents a particular activity and gives the volume of activities for the production of all products.

9. A method according to claim 7, including the step of pre-multiplying the matrix by R to give resources by activities matrices.

10. A method according to claim 9, including the step of pre-multiplying the matrix by p′ to give dollars by activities vectors.

11. A method according to claim 7 including the step of expressing all services that belong in an organization unit in a single column of the matrix.

12. (canceled)

13. (canceled)

14. A method according to claim 1, including the step of combining the variables R, U and m to obtain the variable of interest RUm which represents volume of resources.

15. A method according to claim 14, wherein the matrix is a diagonal matrix and each column of the matrix represents a particular resource and gives the volume of resources for all activities for the production of all products.

16. A method according to claim 15, including the step of pre-multiplying the matrix by p to give dollars for resources vectors.

17. A method according to claim 14, including the step of expressing all resources acquired in a single column of the matrix.

18. (canceled)

19. (canceled)

20. A method of cost variance analysis using p′RUm analysis, having variables p (price), R (efficiency), U (utilization) and m (product mix), at least one of the variables being a variable of interest comprising a plurality of influencing factors, having an improvement comprising:
(a) expressing the variable of interest as a matrix having a plurality of columns, each column representing an influencing factor; and
(b) assessing the impact of an influencing factor on cost variance attributable to said variable of interest.

21. A method of revenue and profit variance analysis using an extension of p′RUm analysis, having variables sp (selling price) and m (product mix), at least one of the variables being a variable of interest, comprising:
(a) determining profit and revenue variances between actual and budgeted revenues; and
(b) assessing impact of an influencing factor or profit and revenue variance attributable to said variable of interest.

22. A cost variance analysis system comprising:
(a) means for assessing variables p (price), R (efficiency), U (utilization) and m (product mix), at least one of the variables being a variable of interest comprising a plurality of influencing factors;
(b) means for expressing the variable of interest as a matrix having a plurality of columns, each column representing an influencing factor; and
(c) means for conducting p′RUm analysis according to Broyles and Lay, substituting the matrix for the variable of interest.

23. A cost variance analysis system of claim 22 including means for storing the variables.

24. A computer readable medium containing computer-executable instructions which, when performed by a processor in a cost variance analysis system, cause the processor to:
(a) assess variables p (price), R (efficiency), U (utilization) and m (product mix), at least one or the variables being a variable of interest comprising a plurality of influencing factors;
(b) express the variable of interest as a matrix having a plurality of columns, each column representing an influencing factor; and
(c) conduct p′RUm analysis according to Broyles and Lay, substituting the matrix for the variable of interest.

25. A method of cost variance analysis using p′RUm analysis according to Broyles and Lay, the improvement comprising substituting the R_{b} matrix with a matrix consisting of a selected column of differences obtained by subtracting corresponding columns in matrices Rₐ and R_{b}; and populating the other columns of the substituted matrix by zero values, the selected column corresponding to a selected activity.

26. A method of cost variance analysis according to claim 25, including the step of multiplying the substituted matrix by a budgeted price row vector to yield a row vector representing the difference in unit cost of a product.

27. A method according to claim 26, including the step of diagonalizing the substituted matrix and the row vector.

28. A method according to claim 27, including multiplying the diagonalized row vector by the m_{b} matrix to yield the total change of costs for each product attributable to changes in efficiency of the selected activity.

29. A method according to claim 28, including multiplying the total change of costs product by the U_{b} matrix to yield the total change in costs of resources attributable to changes in efficiency of the selected activity.

30. A cost variance analysis report including variances selected from the group comprising variances attributable only to changes in efficiency, resource conversion efficiency variance, cost variance components for activities, resource conversion efficiency variance, cost variance components for resources.
